(19) United States
(12) Patent Application Publication
(10) Pub. No.: US 2023/0361985 A1
(43) Pub. Date: Nov. 9, 2023

(54) IN-COMPUTER OFFLINE STORAGE (ICOS) TO ACHIEVE ZERO VULNERABILITY COMPUTING (ZVC)

(71) Applicant: Fazal Raheman, Nagpur (IN)

(72) Inventor: Fazal Raheman, Nagpur (IN)

(21) Appl. No.: 18/245,026

(22) PCT Filed: Sep. 26, 2022
(86) PCT No.: PCT/IB2022/059134

§ 371 Date: Mar. 13, 2023

Related U.S. Application Data
(60) Provisional application No. 63/228,122, filed on Aug. 1, 2021.

(51) Int. Cl. H04L 9/00; G06F 3/06

(52) U.S. Cl. CPC H04L 9/008; G06F 3/0622; G06F 3/0634; G06F 3/0679

(57) ABSTRACT

A Zero Vulnerability computing (ZVC) device by providing offline data storage of Personally Identifiable Info (PII) within a networked computer without compromising any functionalities of the host computing device. A hardware switch or alternatively a software switch or a combination is proposed to provide the control of such in-computer cold storage of data to the user to instantly access offline cold data whenever required. To further secure the data using homomorphic encryption. The above objectives are achieved by: a) Non-volatile memory of NAND or NOR type made accessible to the user via available USB or SD card ports on the host device; b) a toggle switch to control the offline/online status of the stored data; c) further boosting the security of stored data by deploying fully homomorphic encryption for cold storage and creating a buffer (warm storage) between cold and hot storage using partially homomorphic encryption.

### CROSS REFERENCE TO RELATED PATENT APPLICATIONS

The present application refers to a previous U.S. provisional patent application 63/202,188, Aug. 1, 2021.

### TECHNICAL FIELD

The present disclosure generally relates to cybersecurity systems. More particularly, the present disclosure relates to a novel hardware architecture that enables zero-vulnerability computing (ZVC) as a new computing paradigm by creating a switchable offline data storage space within a networkable computing device to secure personally identifiable information (PII) from online risks.

### BACKGROUND

Cybercrime inflicts damages totaling $6 trillion. A hack attack occurs every 39 seconds, and over 300,000 new malwares are created daily. 18,000 vulnerabilities were published in 2020. Today, over 4.5 billion connected devices remain at risk of cyber-attack.

In legacy cybersecurity systems all cybersecurity breaches result from following two paradigms:
1) Computer vulnerabilities resulting from permissions that hackers misuse to create Attack Surface, which can only be reduced, not eliminated, making it a necessary evil;
2) PII (Personally Identifiable Info) remains vulnerable to brute attacks, ID/credential theft, etc. This is essentially because computer-resident PII is accessible if the device is online. As a result, following vulnerabilities are inherent with legacy computing systems:
1) Unavoidable attack surface that bad actors can exploit with malware, and
2) Online availability of PII stored in connected device can be stolen using authentication faking techniques.

In prior art, both paradigms are unassailable. Experts therefore believe, fool-proof cybersecurity is impossible. This disclosure challenges the second paradigm with an easy to use In-Computer Offline Storage (ICOS) solution.

Prior art cybersecurity techniques are limited to strategies that reduce attack surface, and encrypt data stored in online devices to counter these paradigms. These approaches are less than perfect. To comprehensively neutralize these paradigms, we invented Zero Vulnerability Computing (ZVC), a radical cybersecurity approach that:
i) Completely obliterates the attack surface of a computing device, and,
ii) Creates an “In Computer Offline Storage” (ICOS) within a network-connected device hardware itself.

The former approach is tackled in a co-pending application by disclosing a software implementation of Supra OS (SOS) that eradicated computer vulnerabilities by completely obliterating a computer's attack surface that bad actors often exploit to inject malware (U.S. patent Application 63/202,188, May 31, 2021). The latter approach is described in detail in this disclosure. Our work on ZVC is inspired by our earlier patent on circumventing Operating System vulnerabilities for secure transactions (U.S. Pat. No. 7,228,424, Issued Jun. 5, 2007. While SOS addressed the first cybersecurity paradigm, this disclosure is a hardware implementation of ZVC to address the second cybersecurity paradigm via an apparatus, which is a non-volatile memory (NVM) permanently integrated into a host computer, whether externally plugged into the computer's USB or SD card ports, or internally soldered to the computer's motherboard, and configured to store data offline. Such a device is controlled by owner of the data by means of an ON/OFF toggle switch that can be used by the data owner to keep the data offline, or instantly bring it online in communication with the host computer at data owner's behest. The host computer may also authorize a wireless companion device to extend the communication channel between the ICOS device and the companion mobile device, or even the IoT devices in the vicinity.

Any data stored in a networked computing device is considered at risk in prior art.

“The only truly secure system is one that is powered off, cast in a block of concrete and sealed in a lead-lined room with armed guards—and even then, I have my doubts.”—Professor Gene Spafford

“If security were all that mattered, computers would never be turned on”—Dan Farmer
“This is a world in which the promise of secure digital technology turns out to be in many respects a poisoned chalice.”—CLTC, Berkley.

Zero Vulnerability Computing (ZVC) challenges those notions with a vision of a truly secure system that need not be powered off, cast in a block of concrete and sealed in a lead-lined room, to be secure and immune from hack attacks. Turning on a computer and still keeping the stored data secure, is the impossibility in the prior art that this disclosure challenges.

A revolutionary new approach is proposed of creating in-computer offline storage (ICOS) within a network-connected device to disrupt the status quo on cybersecurity and move towards realizing our ultimate vision of “placing in every hand a computing device that will potentially eradicate cybercrime.

This disclosure also enforces additional lifetime data security (including during data processing) by deploying Homomorphic Encryption techniques and proposes a new hardware architecture design for future computers.

### SUMMARY OF THE INVENTION

In view of the foregoing, it should be apparent that a need exists for a system and method for a zero-vulnerability computing (ZVC) device that provides in-computer offline storage (ICOS) right within the connected computer. The ICOS device data remains offline, but can be instantly switched on/off using a toggle switch.

Accordingly, it would be an improvement to provide a novel computing system that hosts a user controlled secondary offline non-volatile memory (NVM) hardware in addition to the computer's standard online primary NVM storage. It would therefore be an improvement that such in-computer secondary storage of data creates an offline space within an online computer itself, depriving the bad actors access to the data. Consequently, it will also be an unprecedented improvement that such offline data is fully under user's control by means of a toggle switch.

As reasons therefore, it is an object of the present invention to provide an architecture that inherently provides a zero-vulnerability computing (ZVC) apparatus by providing offline data storage of all personally identifiable information (PII) data within a networked computing device without compromising any of the existing functionalities of the host computer. Another object of the invention is to provide the control of such in-computer cold storage of data to the user by means of a hardware switch or alternatively a software switch or a combination thereof, to instantly access the offline cold data for online processing whenever required.

It is still another objective of the invention to deploy non-volatile memory of NAND or NOR type for data storage and make it accessible to the user via any one of the available USB or SD card ports on the host device. It is further object of the invention to inherently integrate such NAND or NOR memory chipset within a host computer as a read only memory (ROM) device, secondary to the computer's primary NVM storage that functions as an instantly switchable offline cold storage vault. It is still another object of the invention to instantly make the offline data available to the user for online processing when required.

It is still further object of the invention to provide such offline storage feature to all types of network-connected computers that include but not limited to a desktop, a laptop, tablet PC, a handheld mobile device, a wearable device, an IoT device, or a remote server. It is further object of this invention to miniaturize the form factor of such in-computer offline storage (ICOS) device for integrating within all types of computing devices without any significant structural changes to their hardware.

It is still further object of the invention to provide in-computer offline storage for one or more digital assets of value that include but not limited to user's biometric data such as fingerprint, voice, face and iris, or cryptocurrency tokens, whether fungible or non-fungible along with their private and public keys. Such ICOS device may operate as a cryptocurrency hardware wallet, a multi-factor authenticator, a biometric authenticator or a PII (personally identifiable information) storage device.

Consequently, it is another object of the invention to immutably assign ownership of such a device to its owner by recording it in a smart contract on a blockchain and minted as a non-fungible token (NFT). The NFT functions as a proof of the device authenticity and ownership.

Yet another object of the invention is to further secure the data using homomorphic encryption by deploying fully homomorphic encryption (FHE) for offline cold storage and creating a buffer (warm storage) between the cold and the hot (online) storage using partially homomorphic encryption (PHE).

The foregoing discussion summarizes some of the more pertinent objects of the present invention. These objects should be construed to be merely illustrative of some of the more prominent features and applications of the invention. The above recited objects are achieved by providing a zero-vulnerability computing device that is network connected, but still provides an in-computer storage that remains offline in cold storage until the user desires to access the data transiently for online processing. Nevertheless, the summary of the invention may not necessarily disclose all the features essential for defining the invention, and: the invention may reside in a sub-combination of the disclosed features. Applying or modifying the disclosed invention in a different manner can attain many other beneficial results as will be described in detail herein. Accordingly, referring to the following drawings may have a complete understanding of the invention and its preferred embodiments.

### BRIEF DESCRIPTION OF THE DRAWINGS

The accompanying drawings are included to provide a further understanding of the present disclosure, and are incorporated in and constitute a part of this specification. The drawings illustrate several exemplary embodiments of the present disclosure and, together with the description, serve to explain the principles of the present disclosure. The diagrams are for illustration only, which thus is not a limitation of the present disclosure, and wherein:

FIG. 1 illustrates exemplary graphic explanation of the ICOS as a permanently mounted external mini-USB device implementation using a host computer-resident Soft Switch application to either keep the data storage offline or switch it online.

FIG. 2 illustrates exemplary graphic explanation of the ICOS as a permanently mounted external mini-USB device implementation using an ICOS-resident Hard Toggle Switch to either keep the data storage offline or switch it online.

FIGS. 3a and 3b illustrate ICOS as a chipset components assembly seamlessly integrated within a host computer for user controlled in-computer offline personal data storage with external user-controlled switch flushing with computer housing.

FIG. 4 illustrates the operation of ICOS in sync with a companion mobile device.

FIG. 5a illustrate an embodiment of ICOS with a hardware toggle switch implemented using existing Micro SD Card slot in a mobile device or IoT device.

FIG. 5b further illustrate ICOS Implementation with a hardware toggle switch using existing MicroSD Card slot in a mobile or IoT device.

FIG. 6a illustrates 3 states of data: Traditional vs Homomorphic Encryption

FIG. 6b illustrates deployment of homomorphic encryptions to create 3 states of data stores for balancing security with speed of data processing in accordance with an exemplary embodiment of the present disclosure.

### DETAILED DESCRIPTION OF DRAWINGS

It is advantageous to define several terms before describing the invention. It should be appreciated that the following terms are used throughout this application. Where the definition of term departs from the commonly used meaning of the term, applicant intends to utilize the definitions provided below, unless specifically indicated otherwise. Therefore, for the purpose of this description the terms used in describing this invention are defined as follows:

NVM: Non-Volatile Memory

NAND Flash is a type of NVM storage technology that does not require power to retain data.

NOR Flash is another type of NVM storage technology that does not require power to retain data.

USB: Universal Serial Bus

USB Port: A standard connection interface for personal computers and consumer electronics devices. It comprises of Female connector found on the host computer and a corresponding Male connector to mount on the host computer any peripheral functionality

SD card & Slot: Like USB port most computers and consumer devices may also have a slot that allows you to insert a secure digital memory card.

PII: Personally Identifiable Information

ICOS: In-Computer Offline Storage

Cold Storage: Offline data storage

Hot Storage: Standard online data storage

Warm Storage: A buffer storage between hot and cold wherein the data is encrypted using partial homomorphically encryption (PHE) algorithm while remaining in cold or hot state

Wallet: A small software program used for online purchase transactions

Hardware Wallet: An NVM hardware device for offline storage of digital assets

HE: Homomorphic Encryption

FHE: Fully Homomorphic Encryption

PHE: Partially Homomorphic Encryption

NFT: Non-Fungible Token

ZVC: Zero Vulnerability Computing

The following is a detailed description of several embodiments of the disclosure illustrated in the accompanying drawings. The embodiments are in such detail as to clearly communicate the disclosure. However, the amount of details offered is not intended to limit the anticipated variations of embodiments; on the contrary, the intention is to cover all modifications, equivalents, and alternatives falling within the spirit and scope of the present disclosure. Numerous specific details are set forth in order to provide a thorough understanding of several embodiments of the present invention. It will be apparent to one skilled in the art that embodiments of the present invention may be practiced without some of these specific details.

As disclosed herein, the core functionality of this invention is introducing a highly secure offline cold storage for PII data within any connected computing device. In order to achieve such an offline cold storage or create an un-hackable ICOS within a network-connected computing device, it is best that such storage hardware integrated without any major structural changes to host computer's motherboard or its housing. This is implemented via a novel utilization of the USB port or SD slots available on almost all the prior art computing devices and connecting them with switchable flash memory chip of NAND or NOR type. Such secondary memory hardware, permanently mounted on the host computer ports serve as the epicenter of the in-computer offline storage (ICOS) that this invention creates within a host computing device.

A host computer is a network connected desktop, a laptop, tablet PC, a handheld mobile device, a wearable device, an IoT device, or a remote server. The host computer may extend the communication channel between ICOS and other companion or satellite devices such as a smartphone, a smartwatch or a wearable IoT device.

In the current state-of the-art, a network connected computer is never considered as fully secure. In other words, a connected device will always remain vulnerable to data hacks unless it is taken offline. The present invention strives to change that maxim by creating a secure NAND or NOR flash memory type offline data storage within any conventional computer of the legacy systems. Such offline in-computer data storage or ICOS, remains at all times, under full control of the owner of the data, wherein the data can be switched online/offline at will, eliminating or minimizing its exposure to the perils of network vulnerabilities. The ICOS device is a tiny form factor removable NVM ROM device that permanently mounts on the host computer via either USB or SD port for offline data storage by default, only to be transiently switched on for data transfer or processing by the data owner, and functions as in-computer offline cold storage vault. Hence, in essence, ICOS device is of NAND or NOR flash type data storage device with form factor so compact that the device can remain attached to the computer at all times without harming the USB port or causing any inconvenience if mounted externally. ICOS can also be internally integrated with any standard motherboard, warranting no structural alterations either to the mother board or the computer housing.

The ICOS typically include software instructions that are stored in NVM hardware (also referred to as secondary memory), which is a MUDP chip integrated within the host computer as a read only memory (ROM) device, secondary to the computer's primary NVM data storage, and functions as offline cold storage vault that can be instantly switched online by the owner of the data. It is mounted on either the USB port or the SD slot of a host computer permanently. When the software instructions are executed, at least a subset of the software instructions can be loaded into RAM memory by a processor. The processor then executes the software instructions in the ICOS NVM hardware. The processor may be a shared processor, a dedicated processor, or a combination of shared or dedicated processors.

A typical ICOS program include calls to the autorun function and retains the focus as long as it is running on the host computer. Such focus does not allow any other host computer application or process to run concurrently, thus disallowing read/write permissions to any host computer resident program. This completely isolates the ICOS hardware from the host computer milieu not only when the ICOS is switched offline, but when it is active and online.

The ICOS application dominates the host computer environment unless the user exits ICOS, at which point the ICOS hardware automatically ejects making it invisible and inaccessible to the user and the data connectivity between the host computer and the ICOS ceases, although the ICOS NVM hardware remains mounted on the host computer. The data assets stored in the ICOS device are either personally identifiable information (PII) or one or more digital assets of value that include but not limited to user's biometric data such as fingerprint, voice, face and iris, or cryptocurrency tokens, whether fungible or non-fungible along with their private and public keys. Such ICOS device may operate as a cryptocurrency hardware wallet, a multi-factor authenticator, a biometric authenticator or a PII storage device. The ownership of such a device can be immutably recorded in a smart contract on a blockchain and minted as a non-fungible token (NFT). The NFT functions as proof of the device's authenticity and ownership.

In a preferred embodiment ICOS can be deployed by a user to boost the security of a user's personal data infinitely by making the data inaccessible to hackers or bad actors in the following steps:
saving the data on a non-volatile memory (NVM) device endowed with a user controlled ON/OFF toggle switch, wherein the NVM device is either permanently mounted on to a network-connected host computer via its external USB or SD-card port, or mounted internally on the host computer's motherboard,
encrypting the data through its entire lifecycle with homomorphic encryption (HE) schemes,
switching on the direct communication channel between the ICOS device and the host computer or its wireless companion device to allow online processing of the data saved on the ICOS device,
switching off the communication channel promptly as soon as the desired processing is accomplished either voluntarily by the user or via an automatic inactivity alert from the system, and,
by default, retaining the stored data in offline state irrespective of whether the host computer remains connected.

The apparatus implementing ICOS method is any network-connected host computer including but not limited to a desktop, a laptop, a tablet PC, a handheld mobile device, a wearable device, an IoT device, or a remote server, and the wireless companion device is a smartphone, a smartwatch or a wearable IoT device.

It may be appreciated by the person skilled in the art that all in-computer data storage remains online in a networked computer and remains vulnerable to hack attacks by bad actors. It should also be noted that without such vulnerable NVM storage a computer will be of limited use. The in-computer NVM storage is therefore “a necessary evil” in prior art. From the perspective of the disclosure of this invention, the ICOS serves as secondary NVM to legacy computers' primary NVM with a difference that the ICOS NVM can remain offline at user's behest, and instant switched online for processing when desired.

Several embodiments of the ICOS in-computer offline storage can be implemented. Six of them are instructive and illustrated in this disclosure. Many more may be appreciated by the person skilled in the art, and are explicitly covered by this disclosure.

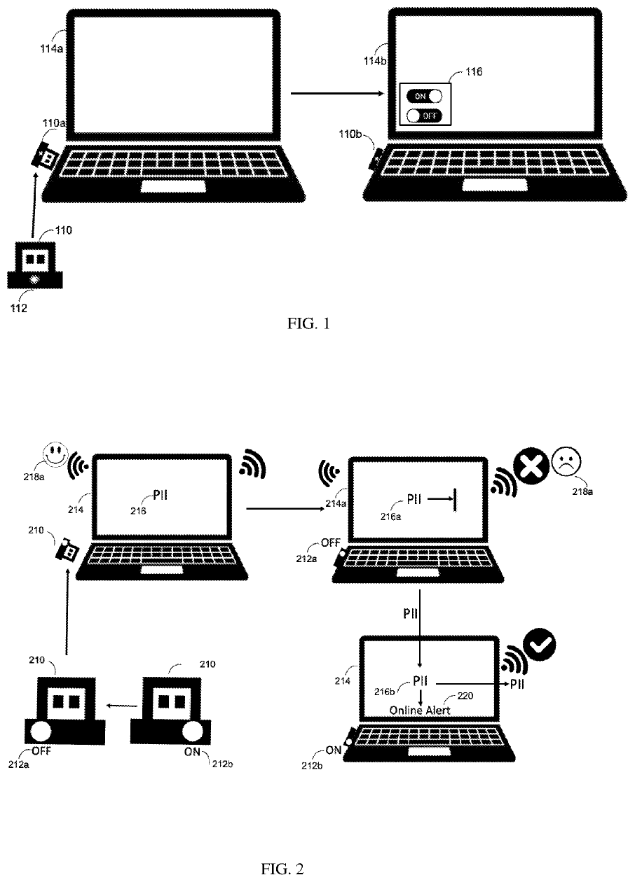

FIG. 1 illustrates a specially designed exemplary ICOS NVM device 110 that bears an indicator LED light 112, which glows to indicate the online status of the data stored in the ICOS device when mounted on either a USB port or a SD slot of a host computer 114. The form factor of such an ICOS device is so small 110a that it can be permanently mounted 110b on the host computer 114a, seamlessly integrating into the contour of the host computer 114b without damaging its USB/SD ports. The NVM device is a MUDP chip integrated within the host computer as a read only memory (ROM) device, secondary to the computer's primary NVM data storage, and functions as integrated offline cold storage vault within the host computer. The offline/online status of the ICOS offline storage device is controlled by a thin software client application 116 installed on the host computer, essentially operating as a toggle switch to either keep the personally identifiable information (PII) data offline or make it accessible online. Such offline/online status of the data is the default status and indicated by the LED that glows only when the data is made accessible online and warns the user to switch off the ICOS to keep the data secure offline. The default offline status of the data can also be automatically maintained by switching off the data connectivity after a period of inactivity.

In another preferred embodiment, as illustrated in the FIG. 2, the ICOS device 210 has a built-in hardware switch 212 that toggles between offline 212a and online 212b mode by means of a physically operable switch. The form factor of the secondary NVM ICOS device 210 in this embodiment is also as tiny as the ICOS Soft Switch device of the previous embodiment illustrated in FIG. 1, but the only difference being the toggle switch is a hardware switch and directly built into the device and need for a LED indicator to show offline/online status is optional. The legacy computing device 214 that stores user's personally identifiable information (PII) 216 remains vulnerable to hack attacks 218 when it operates in a network. However, when the ICOS device 210 is mounted on the host device 214a with its hardware switch in off mode 212a, it creates a secondary offline storage space in addition to the primary NVM storage of the host device. Such secondary offline storage can be permanently mounted on the host device securely storing PII 216a that remains offline and inaccessible to a frustrated hacker 218a, who would be otherwise be happy with accessible PII 218b. The ICOS device 210 remains permanently mounted on the host device 214b, so that whenever the user needs access to the PII data 214a the hardware switch can be temporarily turned on 212b to allow transient access to the stored PII data 216b to execute PII-dependent online transactions. As soon as the desired transaction is completed the ICOS system alerts 220 the user to restore the default offline status of the PII data.

FIG. 2 further illustrates an exemplary MUDP chip 222 and its external layout of pins 224, which may number up to 9 or more, which include input for power supply and grounding. The power supply pinouts can be connected to a toggle switch 226 mounted on the device housing.

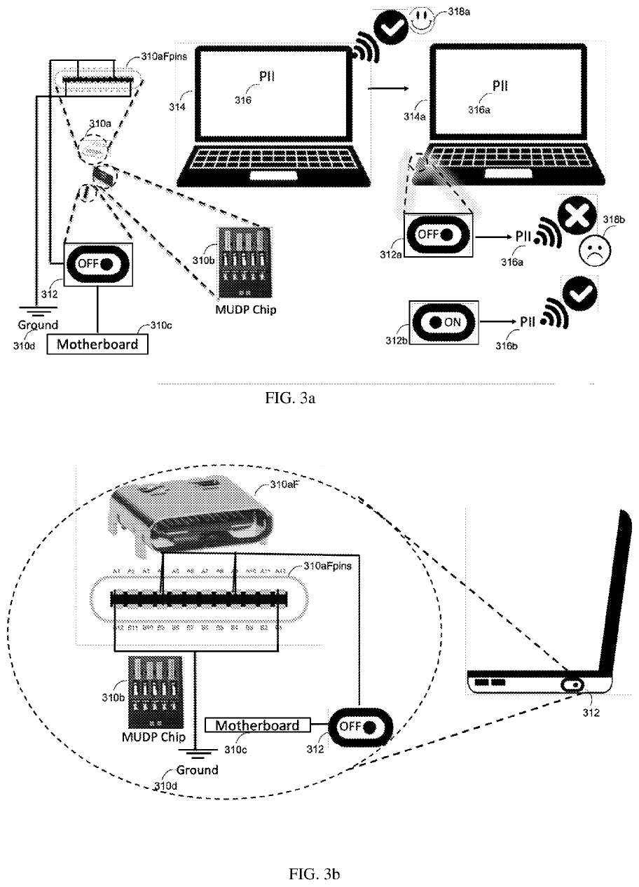

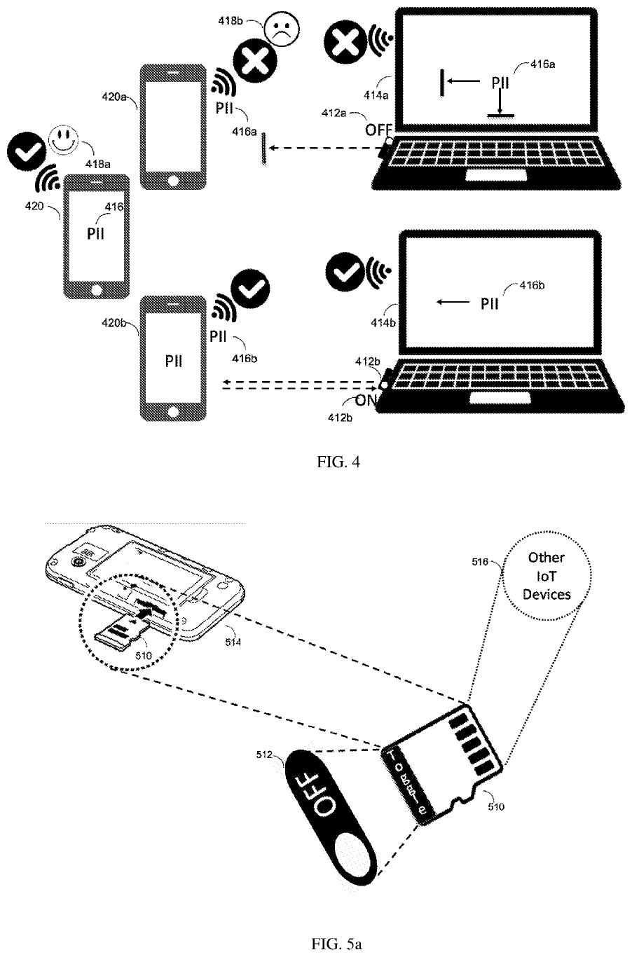

FIGS. 3a and 3b illustrate the third preferred embodiment of the invention. Instead of deploying external removable NVM technology and external ports of the host computer, ICOS Chipset embodiment integrates the secondary offline NVM hardware into a computing device as a part of the computing device manufacturing process. It may be appreciated by the person skilled in the art that all computing devices are built around a motherboard enclosed in a housing. While the legacy motherboards are provisioned with printed circuit board (PCB) that hosts, connects and processes all the essential components of the computing device, such components include ports to allow external devices or peripherals to connect with the host computer. This includes USB ports and SD Card memory slots, wherein the female component of the external hardware is integrated with the motherboard and allows the male component of the external hardware to mount on it as required. A preferred embodiment of this invention exploits these features of prior art computers and discloses an ICOS Chipset iteration of the secondary offline NVM hardware, wherein the embodiment integrates offline NVM within the host computing device without warranting any major alterations to either the legacy motherboard or the computer housing design. As illustrated in FIGS. 3a and 3b, the ICOS 310 essentially comprises of 3 key components making up the assembly. The female motherboard connector 310a that's soldered to the motherboard of the host computing device allows the MUDP chip 310b to mount and stay connected and in data communication with the host devices processor via the motherboard 310c. The female connector 310aF may have as many as 24 pins 310aF pins to handle power supply, data transmission and grounding 310d for safety. The power supply and data connectivity of such an offline NVM hardware assembly is externally controlled by a user-controlled toggle switch 312 that seamlessly fits on one of the USB ports or the SD Slot present on the computing device 314. In legacy systems PII data 316 is stored in the primary NVM that remains accessible and vulnerable to the perils of online cyber-attacks and pleasure of hackers 318a. However, when the ICOS Chipset is installed on the computing device 314a, the PII data 316a can be rendered offline and much safer as further explained herein. When the toggle switch is in OFF mode 312a, the power and data disconnect and the PII data 316a stored in the MUDP chip of the ICOS remains offline and inaccessible to a frustrated hacker 318b. When a user needs to access the offline data for processing the toggle switch can be moved to ON position 312b and the PII data becomes accessible 316b for processing. To maximize the security of the PII data the toggle switch is turned ON only transiently for the data processing, and the brief duration of the online status of the data is further secured using homomorphic encryption (HE) schemes disclosed in detail in yet another embodiment described subsequently. It is also secured against malware attacks by completely obliterating the ICOS devices attack surface as disclosed in a co-pending application that discloses a novel Supra OS application to Zero Vulnerability Computing (ZVC).

FIG. 4 illustrates an embodiment that further expands the applicability of the ICOS offline storage to billions of mobile and IoT devices without actually creating a secondary offline storage within the mobile device itself. It may be appreciated by the person skilled in the art that the PII data 416 stored in a legacy mobile device 420 is as vulnerable to cyber-attacks as the desktop or laptop computers, perhaps more, because a mobile device is almost always online making it easier for hackers 418a. The offline data storage that ICOS creates within the desktop host device can be easily extended to a companion mobile device or its satellite IoT devices without any hardware alterations to such companion or satellite devices.

This embodiment is enabled by storing all PII data 416 on an ICOS of a desktop computer 414, instead of directly storing on the mobile device 420, controlling it with the toggle switch 412. In this embodiment the PII data 416a normally remains switched off 412a and therefore offline and secure on the desktop computing device 414a, and therefore inaccessible to the mobile device 420a as a result frustrating the hacker 418a who targets the mobile device. However, if a genuine processing of the PII data 416b is warranted on the companion mobile device 420b, the toggle switch can be turned on 412b making the data accessible for authorized data processing 416b. Thus, the advantages of ICOS can be extended to mobile devices.

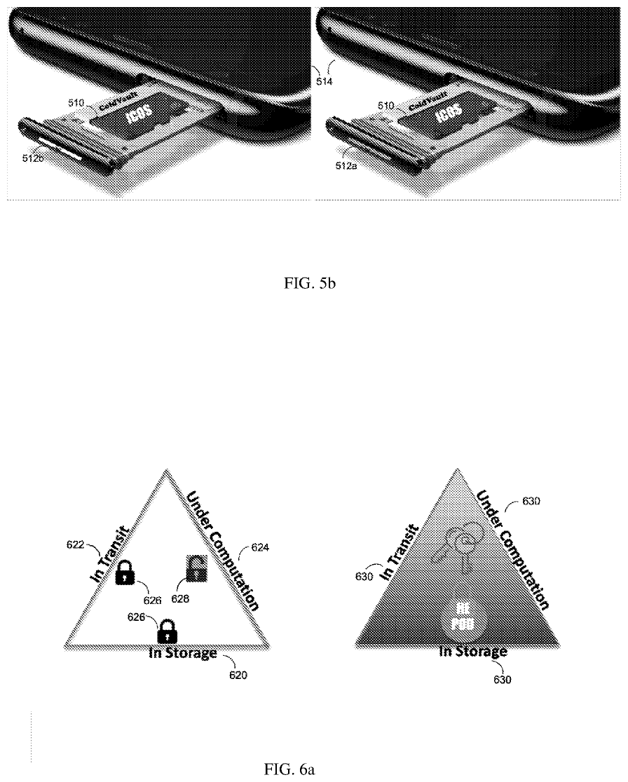

FIG. 5a & b illustrate the direct implementation of ICOS hardware in mobile devices, which constitute majority of over 4.5 billion devices out there. As most mobile devices 514 come with MicroSD card slot, this embodiment takes advantage of the MicroSD slot feature to minimize modification to the motherboard or housing design of the legacy mobile devices. The MicroSD card serves as the secondary NVM 510 component of the ICOS hardware, which also includes a toggle switch 512 that connects to the data and power pins of the Micro SD card female connector to control the power supply and data connectivity status 512a (offline) or 512b (online) of the NVM storage of the ICOS mobile chipset assembly. Many IoT devices are also endowed with MicroSD slot, which can be utilized to deploy ICOS in a similar manner 516. Thus, ICOS chipset can also be adapted to directly creating offline storage within the mobile devices and qualified IoT devices.

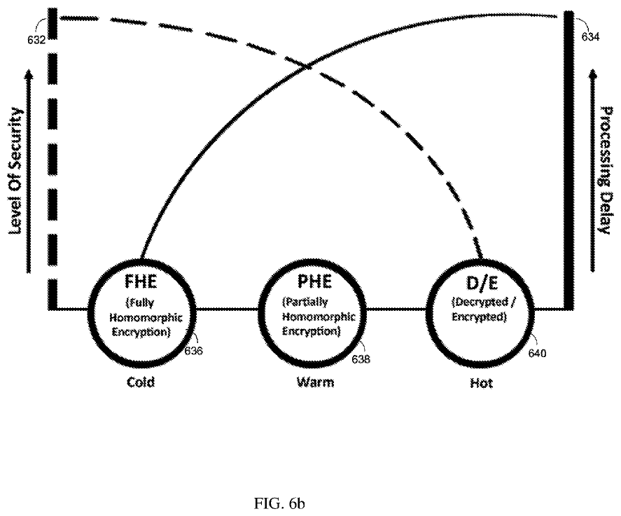

FIGS. 6a and 6b illustrate an embodiment of ICOS that further enhances the security of PII data during the very small window that it becomes accessible online for processing, virtually rendering the data almost eternally secure. During its lifecycle, data exists in 3 different states: Storage 620, Transit 622, & Computation 624. In traditional computing, data remains in encrypted state 626 in storage & transmission, but decrypted 628 when used for computation. However homomorphic encryption (HE) algorithms allow computation of encrypted data without sharing secret key and therefore remains encrypted 630 in all the three states. HE schemes are next generation algorithms for computations on ciphertexts without need to decrypt or reveal it. In distributed cloud computing context this is a highly precious power. But computation-intense HE schemes although provide level of security 632, HE renderings are excruciatingly slow 634 & impractical However, in the context of provisioning of offline data storage within a networked computer, and securing it during its short periods of online exposure, the HE latency can be potentially deployed to a unique advantage that further boosts the additional security barrier that HE creates in the context of ICOS functionality. What this essentially means is that between the cold storage secured by FHE 636, a transitional warm storage is created which lowers the HE protection to PHE 638 and acts as a buffer between cold 632 and decrypted hot 640, and also speeds up the transition time between warm and hot storage. Thus, such novel deployment of HE schemes balances data security with transaction speed.

In an exemplary embodiment, Zero Vulnerability Computing (ZVC) can be fully achieved by combining ICOS with complete obliteration of attack surface of a computer with Supra OS deployment as disclosed in our co-pending application. In another exemplary embodiment, a comprehensive ZVC is implemented via an external USB or ICOS device. In yet another exemplary implementation, such external USB ICOS device is a user authentication device. In still another embodiment the ICOS is a personal online data (POD) store.

In another exemplary implementation the ownership of the ICOS device is immutably recorded in a smart contract on a blockchain and minted as a non-fungible token (NFT) serving as a certificate of authenticity of the device. In still another exemplary implementation, ZVC is implemented as a compact Zero Vulnerability Operating System (ZVOS), particularly for IoT devices, that not only provides ICOS but completely obliterates the attack surface present on the IoT device or its firmware, by rescinding all permissions and privileges to third party applications and providing its own user interface for running all third-party applications remotely as web applications. ZVOS can enable IoT device development by adapting to a minimalistic requirement of the IoT devices limited by their processing power and limited range of third-party applications.

In yet another exemplary implementation, ZVOS runs as a thin client from either a NAND or NOR flash drive or any legacy data storage device ported to one or more legacy computing devices including but not limited to a desktop, a laptop, tablet PC, a handheld mobile device, a wearable device, an IoT device, or a remote server running one of the commercially available operating systems that include but not limited to Microsoft Windows, Apple macOS, iOS, Linux, Google Android, Chromium, or any of the variants thereof. In such ZVOS implementation of a thin ICOS device, which is either permanently mounted on the USB port of the host computer or integrated within the motherboard of the host computer.

In still another exemplary implementation the ZVOS software integrates blockchain to securely share computing resources or bandwidth with peers for tokenized rewards, and to decentralize, anonymize and secure data storage of all personally identifiable information (PII) of the users that include but not limited to self-sovereign identity, personal biometric, financial and social data. Such ZVOS/ICOS hardware may also be implemented on a computing device as a web browser or a browser extension or a thin client.

As used herein, the term engine refers to software, firmware, hardware, or other component that can be used to effectuate a purpose. The engine will typically include software instructions that are stored in non-volatile memory (also referred to as secondary memory). When the software instructions are executed, at least a subset of the software instructions can be loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term “computer” is a general-purpose device that can be programmed to carry out a finite set of arithmetic or logical operations. Since a sequence of operations can be readily changed, the computer can solve more than one kind of problem. A computer can include of at least one processing element, typically a central processing unit (CPU) and some form of memory. The processing element carries out arithmetic and logic operations, and a sequencing and control unit that can change the order of operations based on stored information. Peripheral devices allow information to be retrieved from an external source, and the result of operations saved and retrieved.

As used herein, the term “Internet” is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The communications infrastructure of the Internet consists of its hardware components and a system of software layers that control various aspects of the architecture.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Several embodiments of the present invention have been specifically illustrated and described herein. However, it will be appreciated that modifications and variations of the present invention are covered by the above teachings. While the preferred embodiments of the present invention have been illustrated in detail herein, it should be apparent that modifications and adaptations to those embodiments may occur to one skilled in the art without departing from the scope of the present invention as set forth in the following claims. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. Finally, for the purpose of clarity, details relating to technical material that is known in the technical fields related to the invention have not been described in detail so as not to unnecessarily obscure the present invention.

1. An in-computer offline storage (ICOS) apparatus, comprises of:
a non-volatile memory (NVM) device permanently integrated into a host computer either internally on to the computer's motherboard or externally mounting on to a computer's USB or SD card ports;
configured to store data, wherein the data is controlled by means of an ON/OFF toggle switch;
wherein the toggle switch configured to be used by a data owner to keep the data offline or instantly bring it online in communication with the host computer or a wireless companion device or a satellite IoT devices at data owner's behest.

2. An in-computer offline storage (ICOS) apparatus of claim 1, wherein the toggle device can be a resident USB's hardware switch or host computer-resident soft switch.

3. The in-computer offline storage (ICOS) apparatus of claim 1 wherein the host computer is a network connected desktop, a laptop, tablet PC, a handheld mobile device, a wearable device, an IoT device, or a remote server, and the wireless companion device is a smartphone, a smartwatch or a wearable IoT device.

4. The in-computer offline storage (ICOS) apparatus of claim 1 wherein the NVM device is a MUDP chip integrated within the host computer as a read only memory (ROM) device, secondary to the computer's primary NVM data storage, and functions as offline cold storage vault that can be instantly switched online by the owner of the data.

5. The in-computer offline storage (ICOS) apparatus of claim 1 wherein the ICOS device is a tiny form factor removable ROM device that permanently mounts to the host computer via either USB or SD port for offline data storage by default, only to be transiently switched on by a toggle switch for data transfer or processing by the data owner, and functions as in-computer offline cold storage vault.

6. The in-computer offline storage (ICOS) apparatus of claim 1 wherein the ICOS device is of NAND or NOR flash type data storage device with form factor so compact that the device can remain attached externally to the computer at all times without harming the USB port or causing any inconvenience, and if internally integrated with any standard motherboard, warrants no structural alterations either to the motherboard or the computer housing.

7. The in-computer offline storage (ICOS) apparatus of claim 1 wherein the data assets stored in the ICOS device are either personally identifiable information (PII) or one or more digital assets of value such as fingerprint, voice, face and iris, or cryptocurrency tokens, whether fungible or non-fungible along with their private and public keys.

8. The in-computer offline storage (ICOS) apparatus of claim 1 wherein the access to the data stored is further secured by deploying homomorphic encryption, particularly fully homomorphic encryption (FHE) and partial homomorphic encryption (PHE) as appropriate, for maximum protection through the life of the data and particularly during the transition of the data from cold (offline) to hot (online), wherein PHE algorithm create a buffer (warm) between cold and hot storage.

9. The in-computer offline storage (ICOS) apparatus of claim 1 wherein the ICOS device configured to be a cryptocurrency hardware wallet, a multi-factor authenticator, authenticator or a PII storage device, the ownership of which device is immutably recorded in a smart contract on a blockchain and minted as a non-fungible token (NFT).

10. A method of in-computer offline storage (ICOS) for infinitely boosting the security of personally identifiable information (PII) comprising of steps of:
storing the data on a non-volatile memory (NVM) device endowed with a user controlled ON/OFF toggle switch, wherein the device is either permanently mounted on to a network-connected host computer via its external USB or SD-card port, or mounted on the host computer's motherboard;
encrypting the data through its entire lifecycle with homomorphic encryption (HE) schemes;
using a toggle switch to switch ON the direct communication channel between the ICOS device and the host computer or a wireless companion device to allow online processing of the data saved on the ICOS device,
switching OFF the communication channel promptly as soon as the desired processing is accomplished either voluntarily by the user or via an automatic inactivity alert from the system; and retaining the stored data in offline state irrespective of whether the host computer remains connected in default configuration.

11. The method of claim 10, wherein the toggle device can be a resident USB's hardware switch or host computer-resident soft switch.

12. The method of claim 10 wherein the network-connected host computer is a desktop, a laptop, a tablet PC, a handheld mobile device, a wearable device, an IoT device, or a remote server, and the wireless companion device is a smartphone, a smartwatch or a wearable IoT device.

13. The method of claim 10, wherein the ICOS apparatus is a MUDP chip permanently integrated within the host computer as a read only memory (ROM) device, secondary to the computer's primary NVM storage for offline data storage by default, only to be transiently switched on for data transfer or processing by the data owner, and functions as in-computer offline cold storage vault.

14. The method of claim 10, wherein the ICOS device is of NAND or NOR flash type data storage device and the ON/OFF switch is a device-resident hardware switch or host computer resident software switch.

15. The method of claim 10, wherein the PII data assets stored in the NVM device include but not limited to user's biometric data such as fingerprint, voice, face and iris, or cryptocurrency tokens, whether fungible or non-fungible along with their private and public keys.

16. The method of claim 10, wherein the ICOS device is a cryptocurrency hardware wallet, a multi-factor authenticator, or a biometric authenticator, the ownership of which is immutably recorded on a blockchain and minted as an NFT.

17. The method of claim 10, wherein the access to the data stored is further secured by deploying homomorphic encryption, particularly fully homomorphic encryption (FHE) and partial homomorphic encryption (PHE) as appropriate, for maximum protection through the life of the data and particularly during the transition of the data from cold (offline) to hot (online), wherein PHE algorithm create a buffer (warm) between cold and hot storage.
